(19) United States
(12) Patent Application Publication
(10) Pub. No.: US 2015/0002275 A1
(43) Pub. Date: Jan. 1, 2015

(54) METHODS, APPARATUSES, AND COMPUTER PROGRAM PRODUCTS FOR DATA TRANSFER BETWEEN WIRELESS MEMORY TAGS

(71) Applicant: Nokia Corporation, Espoo (FI)

(72) Inventors: Joni Jantunen, Helsinki (FI); Jan-Erik Ekberg, Vantaa (FI); Mikko Uusitalo, Helsinki (FI); Jani Ollikainen, Helsinki (FI)

(21) Appl. No.: 13/927,869

(22) Filed: Jun. 26, 2013

(51) Int. Cl. G06F 13/38; G06F 3/0488; G06K 7/10; G06F 3/0481

(52) U.S. Cl. CPC G06F 13/38; G06F 3/04817; G06F 3/04883; G06K 7/10297
USPC 340/10.51

(57) ABSTRACT

Methods, apparatuses, and computer program products are herein provided for transferring data between wireless memory tags. A method may include determining that a first wireless memory tag is proximate to a device, wherein the first wireless memory tag comprises data. The method may further include receiving user input indicating a desire to transfer at least some of the data from the first wireless memory tag to a second wireless memory tag. The method may further include causing the at least some of the data to be transferred from the first wireless memory tag to the device. The method may further include determining that the second wireless memory tag is proximate to the device. The method may further include causing the at least some of the data to be transferred from the device to the second wireless memory tag in response to a release of the user input. Corresponding apparatuses and computer program products are also provided.

### TECHNOLOGICAL FIELD

An example embodiment of the present invention relates generally to user interface technology and, more particularly, relates to methods, apparatuses, and computer program products for transferring data between wireless memory tags.

### BACKGROUND

The modern communications era has brought about a tremendous expansion of wireline and wireless networks, thereby providing more flexibility and immediacy of information transfer. Moreover, an expansion in computing power has resulted in development of affordable mobile computing devices capable of taking advantage of services made possible by modern networking technologies. Indeed, mobile computing devices can be used to perform a variety of functions.

### BRIEF SUMMARY

Wireless memory tags are becoming increasingly common in the world and provide an easy means to store data, such as files including pictures and videos. Further, some wireless memory tags do not require a battery. Some mobile computing devices may be capable of reading data from wireless memory tags and writing data to wireless memory tags.

Some embodiments of the present invention seek to provide an easy to use interface for mobile computing devices that enable a user to quickly and easily read data from and write data to such wireless memory tags. In one example embodiment, a method includes determining that a first wireless memory tag comprising data is proximate to a device. The method further includes receiving user input indicating a desire to transfer at least some of the data from the first wireless memory tag to a second wireless memory tag. The method further includes causing the at least some of the data to be transferred from the first wireless memory tag to the device. The method further includes causing the at least some of the data to be transferred from the device to the second wireless memory tag in response to a release of the user input.

In some embodiments, the method may further include determining that the second wireless memory tag is proximate to the device. Additionally, in some embodiments, the method may further include automatically causing, in response to determining that the first wireless memory tag is proximate to the device, the at least some of the data to be transferred from the first wireless memory tag to the device.

In some embodiments, the method may further include causing, in response to determining that the first wireless memory tag is proximate to the device, presentation of an icon on a display of the device. The icon may be associated with the at least some of the data stored on the first wireless memory tag. Additionally, in some embodiments, the method may further include receiving user input indicating a desire to transfer the at least some of the data from the first wireless memory tag to a second wireless memory tag by receiving user input directed to the icon. In some embodiments, the user input may define a press and hold gesture. Further, in some embodiments, the method may include receiving the user input by determining that the press and hold gesture is initiated in an instance in which the device is determined to be proximate to the first wireless memory tag and released in an instance in which the device is determined to be proximate to the second wireless memory tag.

In some embodiments, the method may further include causing presentation of the icon on the display by causing presentation of a plurality of icons on the display. Each icon may be associated with different data stored on the first wireless memory tag. Additionally, in some embodiments, the method may include receiving user input indicating a desire to transfer the at least some of the data from the first wireless memory tag to a second wireless memory tag by receiving user input directed to at least one of the icons presented on the display. Moreover, the method may include causing the at least some of the data to be transferred from the first wireless memory tag to the device by causing the data associated with the at least one selected icon to be transferred from the first wireless memory tag to the device. Further, the method may include causing the at least some of the data to be transferred from the device to the second wireless memory tag by causing the data associated with the at least one selected icon to be transferred from the device to the second wireless memory tag.

In some embodiments, the method may include receiving a second user input directed to the icon indicating a desire to delete the at least some of the data associated with the icon. Additionally, the method may include causing deletion of the at least some of the data associated with the icon.

In some embodiments, the user input may define a squeeze gesture. Additionally, in some embodiments, the method may include receiving the user input by determining that the squeeze gesture is initiated in an instance in which the device is determined to be proximate to the first wireless memory tag and released in an instance in which the device is determined to be proximate to the second wireless memory tag.

In another example embodiment, an apparatus comprises at least one processor and at least one memory storing computer program code with the at least one memory and stored computer program code being configured, with the at least one processor, to cause the apparatus to determine that a first wireless memory tag comprising data is proximate to a device. The at least one memory and stored computer program code are configured, with the at least one processor, to further cause the apparatus to receive user input indicating a desire to transfer at least some of the data from the first wireless memory tag to a second wireless memory tag. The at least one memory and stored computer program code are configured, with the at least one processor, to further cause the apparatus to cause the at least some of the data to be transferred from the first wireless memory tag to the device. The at least one memory and stored computer program code are configured, with the at least one processor, to further cause the apparatus to cause the at least some of the data to be transferred from the device to the second wireless memory tag in response to a release of the user input.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method including determining that a first wireless memory tag comprising data is proximate to a device. The method further includes receiving user input indicating a desire to transfer at least some of the data from the first wireless memory tag to a second wireless memory tag. The method further includes causing the at least some of the data to be transferred from the first wireless memory tag to the device. The method further includes causing the at least some of the data to be transferred from the device to the second wireless memory tag in response to a release of the user input.

In another example embodiment, an apparatus is provided. The apparatus comprises means for determining that a first wireless memory tag comprising data is proximate to a device. The apparatus further comprises means for receiving user input indicating a desire to transfer at least some of the data from the first wireless memory tag to a second wireless memory tag. The apparatus further comprises means for causing the at least some of the data to be transferred from the first wireless memory tag to the device. The apparatus further comprises means for determining that the second wireless memory tag is proximate to the device. The apparatus further comprises means for causing the at least some of the data to be transferred from the device to the second wireless memory tag in response to a release of the user input.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates a block diagram of an apparatus according to an example embodiment of the present invention;

FIG. 2 is a schematic block diagram of a mobile terminal according to an example embodiment of the present invention;

FIG. 3 illustrates an example device, such as the apparatus shown in FIG. 1, in communication with a first wireless memory tag, in accordance with an example embodiment of the present invention described herein;

FIG. 4 illustrates the device in contact with the first wireless memory tag, in accordance with an example embodiment of the present invention described herein;

FIG. 5 illustrates the device and first wireless memory tag shown in FIG. 4, wherein a representation of the data stored on the first wireless memory tag is presented on a display of the device, in accordance with an example embodiment of the present invention described herein;

FIG. 6 illustrates the device and first wireless memory tag shown in FIG. 5, with a user providing user input directed to the representation of the data stored on the first wireless memory tag, in accordance with an example embodiment of the present invention described herein;

FIG. 7 illustrates the device shown in FIG. 6, wherein the user continues to provide user input to the device, and wherein the device is moving toward a second wireless memory tag, in accordance with an example embodiment of the present invention described herein;

FIG. 8 illustrates the device and second wireless memory tag shown in FIG. 7, wherein the device and the second wireless memory tag are in contact with each other, in accordance with an example embodiment of the present invention described herein;

FIG. 9 illustrates the device and second wireless memory tag shown in FIG. 8, wherein the user has stopped providing user input and the data from the first wireless memory tag is being transferred to the second wireless memory tag, in accordance with an example embodiment of the present invention described herein;

FIG. 10 illustrates the device and first wireless memory tag shown in FIG. 4, wherein representation of two sets of data of the first wireless memory tag are being presented on the display of the device, in accordance with an example embodiment of the present invention described herein;

FIG. 11 illustrates the device and first wireless memory tag shown in FIG. 4, wherein the representation of data of the first wireless memory tag is being presented within a portion of the display of the device that represents the memory storage of the first wireless memory tag, in accordance with an example embodiment of the present invention described herein;

FIG. 12 illustrates the device and first wireless memory tag shown in FIG. 11, wherein a user is providing user input to the representation of data of the first wireless memory tag such that the representation is being dragged into another portion of the display of the device that represents the memory storage of the device, in accordance with an example embodiment of the present invention described herein;

FIG. 13 illustrates the device shown in FIG. 12, wherein the device has been moved into contact with the second wireless memory tag and wherein a user is providing user input to the representation of data of the first wireless memory tag such that the representation is being dragged into yet another portion of the display of the device that represents the memory storage of the second wireless memory tag, in accordance with an example embodiment of the present invention described herein;

FIG. 14 illustrates the device and first wireless memory tag shown in FIG. 11, wherein a user is providing user input across the representation of data of the first wireless memory tag to indicate the desire of the user to delete the data, in accordance with an example embodiment of the present invention described herein

FIG. 15 illustrates a flowchart according to an example method for transferring data between wireless memory tags, in accordance with an example embodiment of the present invention described herein; and

FIG. 16 illustrates a flowchart according to another example method for transferring data between wireless memory tags, in accordance with an example embodiment of the present invention described herein; and

FIG. 17 illustrates a flowchart according to yet another example method for transferring data between wireless memory tags, in accordance with an example embodiment of the present invention described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

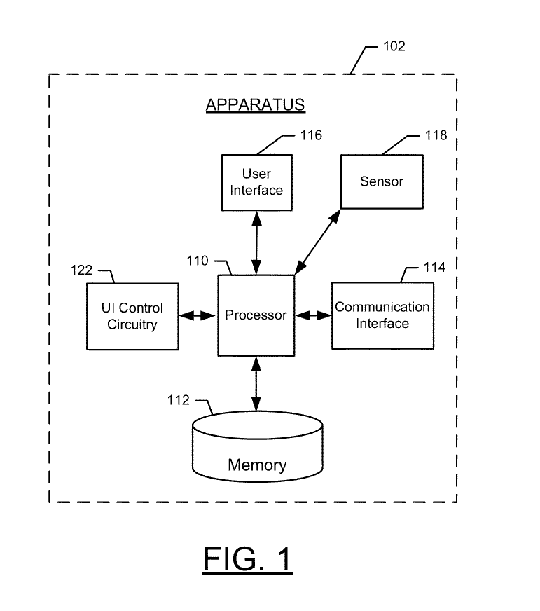

FIG. 1 illustrates a block diagram of an apparatus 102 configured for transferring data between wireless memory tags according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for performing operations and operational routing, other configurations may also be used to implement embodiments of the present invention.

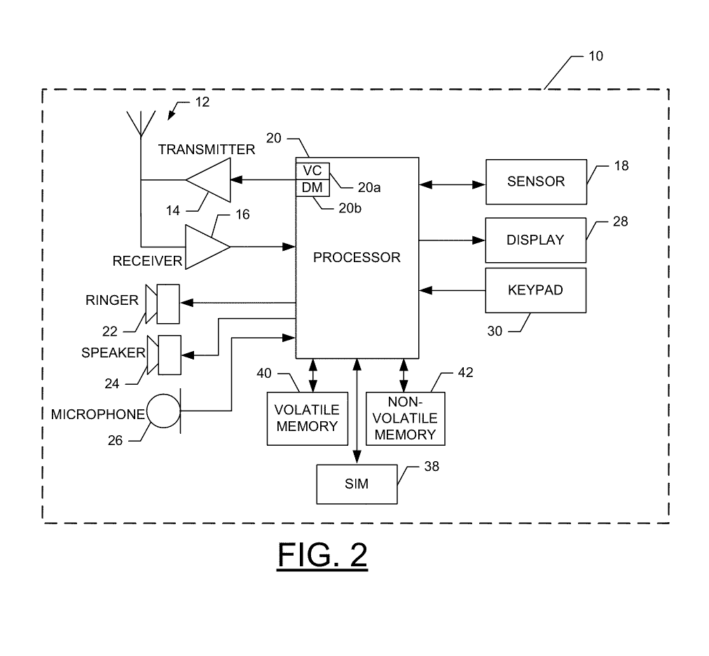

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a user interface (e.g., a touch display capable of displaying a graphical user interface). In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local area network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of communicating according to Wi-Fi, Near Field Communications (NFC), BlueTooth, Worldwide Interoperability for Microwave Access (WiMAX) or other proximity-based communications protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), sensor 18, and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, sensor 118, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, sensor 118, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. Additionally or alternatively, the communication interface 114 may be configured to support communications in accordance with any proximity-based protocol including, for example, Wi-Fi, NFC, BlueTooth, WiMAX or the like. The communication interface 114 may additionally be in communication with the memory 112, user interface 116, and/or UI control circuitry 122, such as via a bus.

The sensor 118 may be in communication with the processor 110, user interface 116, and/or UI control circuitry 122. The sensor 118 may be configured to sense and/or detect user input. For example, in some embodiments, the sensor 118 may be configured to detect an instance in which a user applies a squeeze gesture to a device (e.g., apparatus 102). Additionally, in some embodiments, the sensor 118 may be configured to detect or sense whether the device (e.g., apparatus 102) is proximate to or in contact with a wireless memory tag. In such a manner, the sensor 118 may be configured to provide output indicative of whether the device is proximate to or in contact with a wireless memory tag to the apparatus 102 (e.g., the processor 110). In embodiments wherein the apparatus 102 is embodied as a mobile terminal 10, the sensor 118 may be embodied as or comprise the sensor 18 (shown in FIG. 2). In some embodiments, the sensor 118 may comprise at least one of a pressure sensor, a proximity sensor, a light sensor, an accelerometer, or a gyroscope.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touchscreen display, a microphone, a speaker, a camera, a radar, a sonar and/or other input/output mechanisms. For example, in some embodiments, the user interface 116 may be configured to receive inputs in the form of deformation (e.g., bending, twisting, etc.). In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2), among other example user interfaces (such as those described herein). The user interface 116 may be in communication with the memory 112, communication interface 114, and/or UI control circuitry 122, such as via a bus.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display (e.g., touch screen). The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hover gesture input. A hover gesture input may comprise a gesture input to the touch display without making physical (e.g., direct) contact with a surface of the touch display, such as a gesture made in a space some distance above/in front of the surface of the touch display. As an example, the touch display may comprise a capacitive touch display, which may be configured to enable detection of capacitance of a finger or other input object by which a gesture may be made without physically contacting a display surface. As another example, the touch display may be configured to enable detection of a hover gesture input through use of acoustic wave touch sensor technology, electromagnetic touch sensing technology, near field imaging technology, optical sensing technology, infrared proximity sensing technology, some combination thereof, or the like.

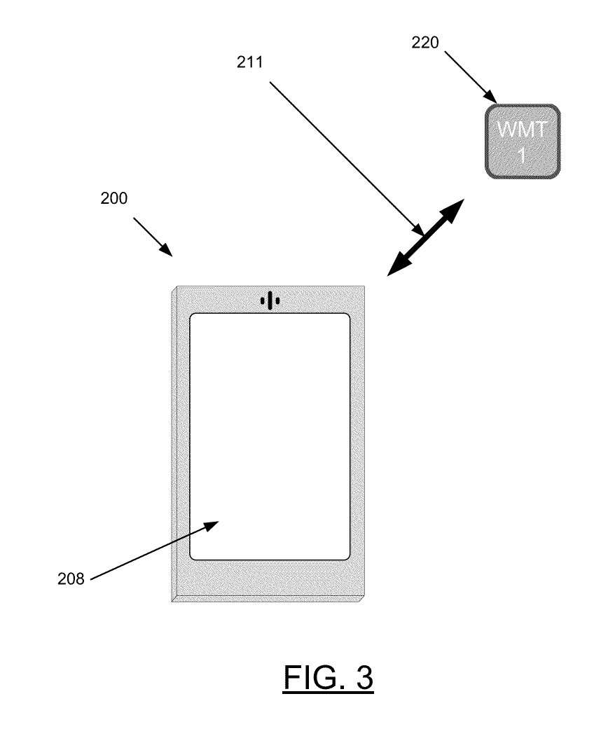

The apparatus 102, such as through the processor 110 and/or communication interface 114, may be configured to read data from and write data to a wireless memory tag. In some embodiments, the apparatus 102, such as through the processor 110 and/or communication interface 114, may be configured to cause at least some of the data stored on a wireless memory tag to be transferred from the wireless memory tag to a device (e.g., the memory 112 of the apparatus 102). Additionally or alternatively, in some embodiments, the apparatus 102, such as through the processor 110 and/or communication interface 114, may be configured to cause data to be transferred to the wireless memory tag, such as to be stored in the memory of the wireless memory tag. For example, FIG. 3 illustrates an example device 200, such as may embody apparatus 102. The device 200 may be in communication with a first wireless memory tag 220, such as through signals 211. In such a regard, the device 200 may be configured to cause transfer of data between the device 200 and the first wireless memory tag 220.

As noted above, some mobile computing devices (e.g., apparatus 102) may be configured to read data from and write data to wireless memory tags. Wireless memory tags may be located anywhere in the world and may be configured to store data. Further, some wireless memory tags do not require a battery. With increased functionality of mobile computing devices, it may be beneficial to provide an easy to use interface for a user to quickly and easily read data from and write data to such wireless memory tags. For example, an easy to use interface for copying data from a first wireless memory tag to a second wireless memory tag may be beneficial for a user of a mobile computing device. In such a regard, some embodiments of the provide methods, apparatus and computer program products for transferring data between wireless memory tags.

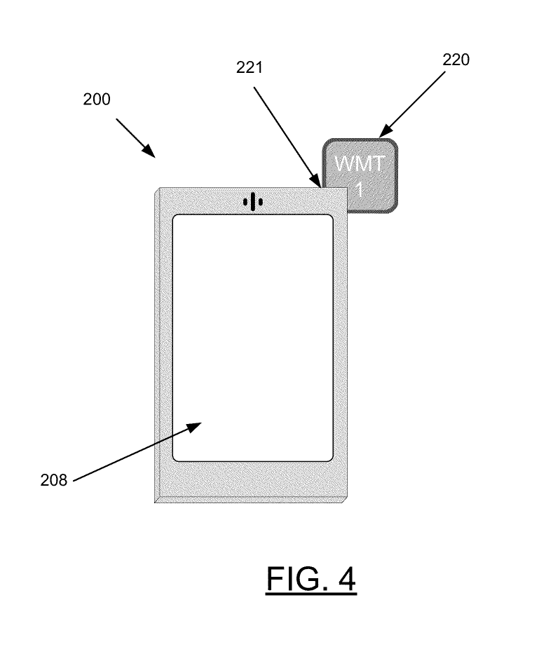

In some embodiments, an apparatus 102, such as through the processor 110, sensor 118, and/or communication interface 114, may be configured to determine that a wireless memory tag is proximate to a device (e.g., apparatus 102). In some embodiments, a wireless memory tag may be considered proximate to a device when the communication interface 114 and/or processor 110 is capable of reading data from or writing data to the wireless memory tag. For example, in some embodiments, the apparatus 102 may be configured to scan for wireless memory tags (e.g., enter a scan mode). Additionally or alternatively, in some embodiments, the wireless memory tag may be considered proximate to the device in an instance in which the device is in physical contact with the wireless memory tag. Additionally or alternatively, in some embodiments, the wireless memory tag may be considered proximate to the device in an instance in which the device is within a threshold distance of the wireless memory tag (e.g., 6 cm, 1 foot, 2 inches, etc.). For example, with reference to FIG. 4, the device 200 may determine that the first wireless memory tag 220 is proximate to the device 200 in an instance in which the device 200 is in contact 221 with the first wireless memory tag 220.

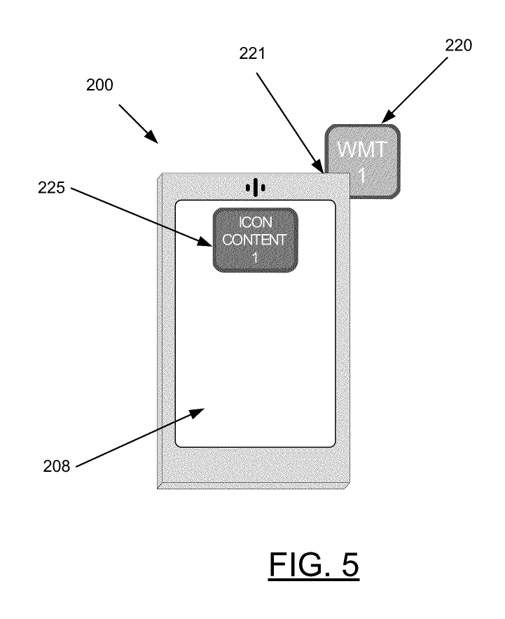

In some embodiments, the apparatus 102, such as through the user interface 116 and/or UI control circuitry 122, may be configured to cause presentation of an icon (e.g., a representation) associated with at least some of the data stored on the wireless memory tag. In some embodiments, causing presentation of the icon on a display of the device may be in response to determining that the device is proximate to the wireless memory tag. For example, with reference to FIG. 5, the device 200 may read at least some data stored on the first wireless memory tag 220 and cause presentation of an icon 225 associated with the data on a display 208 of the device 200. In some cases, the device 200 may automatically cause presentation of the data from the first wireless memory tag 220 in response to determining that the first wireless memory tag 220 is proximate to the device 200.

Though the embodiment described above includes presentation of an icon, some embodiments of the present invention contemplate other representations data, such as pictures, picture thumbnails, video clips, still pictures with moving parts, logos, letters, text or words, including any combinations of the above.

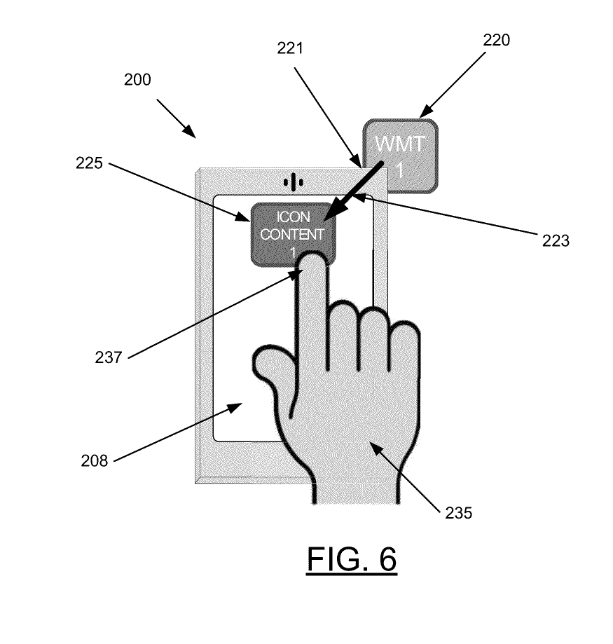

In some embodiments, the apparatus 102, such as through the user interface 116 and/or UI control circuitry 122, may be configured to receive user input indicating a desire to transfer at least some data from a first wireless memory tag. In some embodiments, the apparatus 102, such as through the user interface 116 and/or UI control circuitry 122, may be configured to receive user input indicating a desire to transfer at least some data from a first wireless memory tag to a second wireless memory tag. In some embodiments, the apparatus 102, such as through the user interface 116 and/or UI control circuitry 122, may be configured to receive user input directed to an icon associated with the data of the first wireless memory tag, wherein the user input indicates a desire to transfer that at least some of the data from the first wireless memory tag to a second wireless memory tag. Additionally, in some embodiments, such user input may define a press and hold gesture. For example, with reference to FIG. 6, a user 235 may provide user input to the icon 225 associated with the data stored on the first wireless memory tag 220. In the depicted embodiment, the user 235 performs the user input by pressing or pointing their finger 237 on or near the position of the icon 225 on the display 208 of the device 200. Further, in the depicted embodiment, the user input to the icon 225 is initiated in an instance in which the device 200 is determined to be proximate the first wireless memory tag 220.

In some embodiments, the apparatus 102, such as through the processor 110 and/or communication interface 114, is configured to cause at least some of the data to be transferred from the first wireless memory tag to the device. In some embodiments, the apparatus 102, such as through the processor 110 and/or communication interface 114, is configured to automatically cause at least some of the data stored on the wireless memory tag to be transferred to the device in response to determining that the first wireless memory tag is proximate to the device. In some embodiments, the apparatus 102, such as through the processor 110 and/or communication interface 114, is configured to cause at least some of the data stored on the wireless memory tag to be transferred to the device in response to receiving user input indicating a desire to transfer at least some data from a first wireless memory tag to the device. In some embodiments, the apparatus 102, such as through the user interface 116 and/or UI control circuitry 122, may be configured to receive user input directed to an icon associated with the data of the first wireless memory tag.

In an example embodiment, with reference to FIG. 6, the device 200 may communicate with the first wireless memory tag 220 and cause at least some of the data from the first wireless memory tag 220 to be transferred to the device 200 (e.g., through signal 223).

In some embodiments, the apparatus 102, such as through the user interface 116, may be configured to cause presentation of a progress bar indicating the current status of the transfer of data. Along these lines, in some embodiments, the apparatus 102, such as through the user interface 116, may be configured to cause performance of an indication of completion of the transfer of data (e.g., a sound, vibration, etc.).

In some embodiments, the apparatus 102, such as through the processor 110, sensor 118, and/or communication interface 114, may be configured to determine that a second wireless memory tag is proximate to the device. As is consistent with respect to determining proximity to the first wireless memory tag, in some embodiments, a wireless memory tag may be considered proximate to a device when the communication interface 114 and/or processor 110 is capable of reading data from or writing data to the wireless memory tag. Additionally or alternatively, in some embodiments, the wireless memory tag may be considered proximate to the device in an instance in which the device is in physical contact with the wireless memory tag. Additionally or alternatively, in some embodiments, the wireless memory tag may be considered proximate to the device in an instance in which the device is within a threshold distance of the wireless memory tag (e.g., 6 cm, 1 foot, 2 inches, etc.). In some embodiments, the apparatus 102 may be configured to enter a scan mode after losing connection with the first wireless memory tag (e.g., being removed from being considered proximate to the first wireless memory tag). In such an embodiment, the apparatus 102 may determine that a second wireless memory tag is proximate the apparatus 102 through the scan mode.

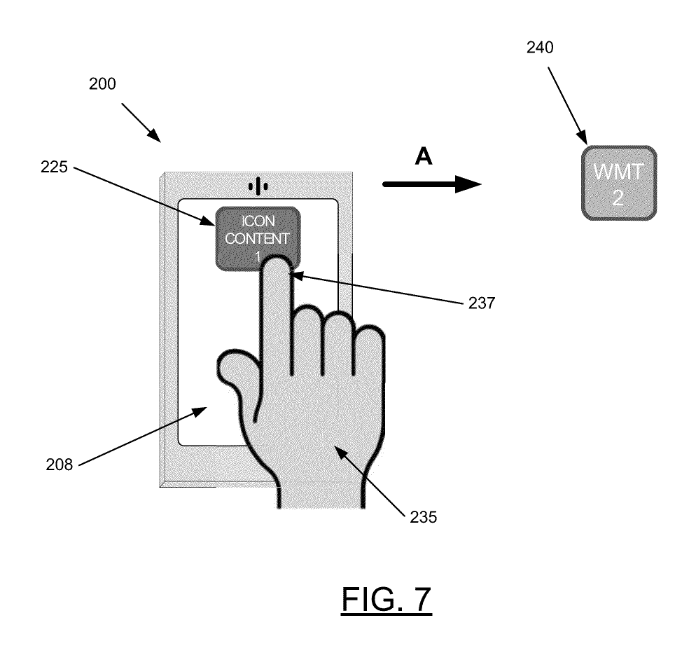

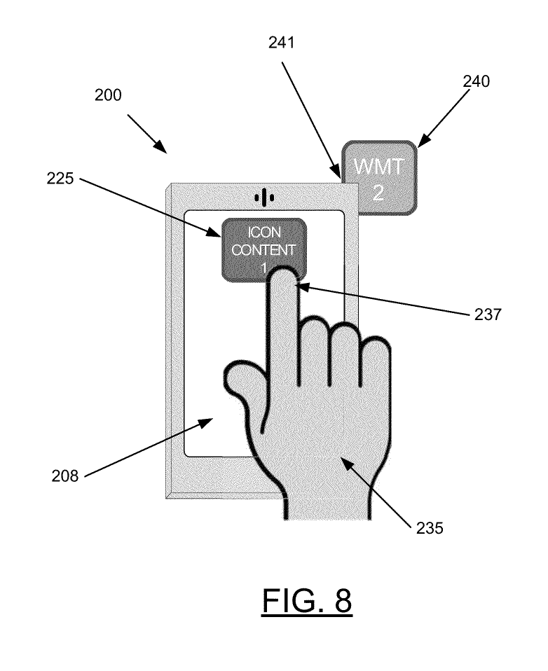

With reference to FIG. 7, in the depicted embodiment, the device 200, to which has been transferred at least some of the data of the first wireless memory tag 220 (shown in FIG. 6), may now be moved toward a second wireless memory tag 240 (e.g., along arrow “A”). Then, with reference to FIG. 8, the device 200 may determine that the second wireless memory tag 240 is proximate to the device 200 in an instance in which the device 200 is in contact with (e.g., 241) the second wireless memory tag 240.

In some embodiments, the apparatus 102, such as through the processor 110 and/or communication interface 114, may be configured to cause at least some of the data to be transferred from the device to the second wireless memory tag. In some embodiments, the apparatus 102, such as through the processor 110 and/or communication interface 114, is configured to automatically cause at least some of the data stored on the device to be transferred to the second wireless memory tag in response to determining that the second wireless memory tag is proximate to the device. In some embodiments, the apparatus 102, such as through the processor 110 and/or communication interface 114, is configured to cause at least some of the data stored on the device to be transferred to the second wireless memory tag in response to receiving user input indicating a desire to transfer at least some data from the device to the second wireless memory tag. In some embodiments, the apparatus 102, such as through the user interface 116 and/or UI control circuitry 122, may be configured to receive user input directed to an icon associated with the data of the device.

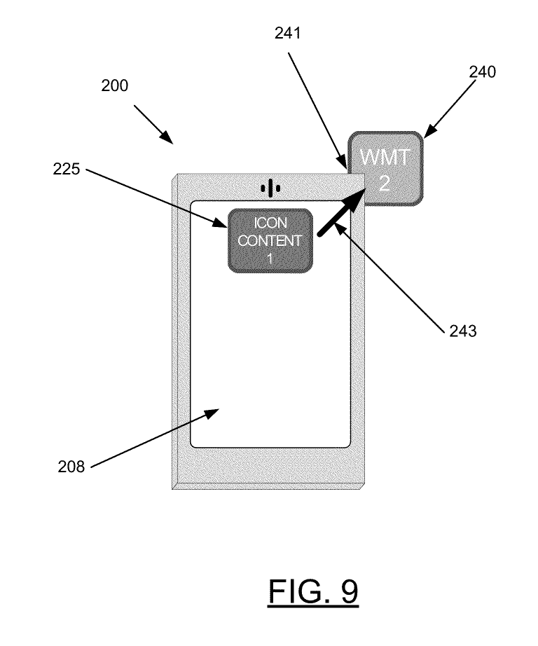

In an example embodiment, with reference to FIG. 9, the device 200 may communicate with the second wireless memory tag 240 and cause at least some of the data from the device to be transferred to the second wireless memory tag 240 (e.g., through signal 243).

In some embodiments, the apparatus 102, such as through the user interface 116, may be configured to cause presentation of a progress bar indicating the current status of the transfer of data. Along these lines, in some embodiments, the apparatus 102, such as through the user interface 116, may be configured to cause performance of an indication of completion of the transfer of data (e.g., a sound, vibration, etc.). Additionally or alternatively, in some embodiments, the apparatus 102, such as through the user interface 116, may be configured to cease presentation of the icon associated with the data being transferred after completion of the transfer of the data.

In some embodiments, the apparatus 102, such as through the processor 110 and/or communication interface 114, may be configured to determine the current storage capacity of the second wireless memory tag. Additionally, in some embodiments, the apparatus 102, such as through the processor 110 and/or user interface 116, may be configured to cause presentation of an indication of the storage capacity of the second wireless memory tag. Along these lines, in some embodiments, the apparatus 102, such as through the processor 110 and/or user interface 116, may be configured to cause presentation of an indication if the storage capacity of the second wireless memory tag is less than the storage capacity requirement of the data to be transferred. Though the above described embodiment details presentation of an indication when the storage capacity of the second wireless memory tag is insufficient, other indications are contemplated by some embodiments of the present invention (e.g., vibration, audible sounds, alarms, blinking of the icon associated with the data, etc.).

In some embodiments, the apparatus 102, such as through the processor 110 and/or communication interface 114, may be configured to compare information associated with a particular set of data (e.g., a filename, a file size, a date, etc.) stored in a wireless memory tag and the information of data being written to the wireless memory tag. Further, in some embodiments, the apparatus 102, such as through the processor 110 and/or user interface 116, may be configured to prompt the user to determine whether the user wants to replace the data in the wireless memory tag with the data being written (e.g., the data stored on the apparatus 102). For example, with reference to FIG. 9, the device 200 may determine the data (e.g., the data associated with icon 225) meant to be transferred to the second wireless memory tag 240 has a filename that is similar to or matches a filename associated with data already saved to the second wireless memory tag 240. As such, the device 200 may prompt the user to decide whether the data meant to be transferred to the second wireless memory tag 240 should write over (e.g., replace) the data already saved to the second wireless memory tag 240.

Alternatively, the same process can be performed when data is being read to a mobile device and a file having sufficiently close identifiers already exists on the mobile device. For example, in some embodiments, the apparatus 102, such as through the processor 110 and/or communication interface 114, may be configured to compare information associated with a particular set of data (e.g., a filename, a file size, a date, etc.) stored on the apparatus 102 and the information of data being written to the apparatus 102 (e.g., from the wireless memory tag). Further, in some embodiments, the apparatus 102, such as through the processor 110 and/or user interface 116, may be configured to prompt the user to determine whether the user wants to replace the data on the apparatus 102 with the data being written to the apparatus 102.

In some embodiments, in addition to maintaining presentation of the icon associated with the data from the first wireless memory tag, the apparatus 102, such as through the user interface 116, may be configured to cause presentation of one or more additional icons associated with data already stored on the second wireless memory tag. In such a manner, the user of the device may be informed of data already stored on the second wireless memory tag.

As noted above, in some embodiments, a simplified transfer of data from a first wireless memory tag to a second wireless memory tag is contemplated herein. For example, in some embodiments, a single user input may be provided to affect the transfer of data. In this regard, in some embodiments, the user input may define a press and hold gesture. For example, in some embodiments, the apparatus 102, such as through the processor 110, user interface 116, and/or UI control circuitry 122, may be configured to receive the user input by determining that a press and hold gesture is initiated in an instance in which the device is determined to be proximate the first wireless memory tag and released in an instance in which the device is determined to be proximate to the second wireless memory tag. For example, with reference to FIG. 6, when the device 200 is proximate the first wireless memory tag 220, the user 235 initiates the press and hold gesture by “pressing” or pointing their finger 237 on or near the position of the icon 225 on the display 208 of the device 200. In response, the device 200 causes a transfer of the data from the first wireless memory tag 220 to the device 200 (e.g., signal 223). Then, with reference to FIG. 7, the user 235 “holds” or maintains the position of their finger 237 as the device 200 moves toward a second wireless memory tag 240 (e.g., along arrow “A”). Finally, with reference to FIGS. 8-9, when the device 200 is proximate the second wireless memory tag 240, the user 235 releases the press and hold gesture by removing their finger 237 from its position. In response, the device 200 causes transfer of the data from the device 200 to the second wireless memory tag 240 (e.g., signal 243).

In some embodiments, with reference to FIG. 7, if the user releases the press and hold gesture prematurely (e.g., before the device 200 is proximate the second wireless memory tag 240), the apparatus 102 may be configured to cease operation of the data transfer. In such a regard, in some embodiments, the device 200 may be configured to cease presentation of the icon 225 from the display 208. This would provide a clear indication to the user of the current status of the data transfer. Alternatively, the device 200 may be configured to maintain presentation of the icon 225 on the display 208 and force the user 235 to reselect the icon 225 in order to affect transfer of the data.

Though a press and hold gesture is described and shown above with respect to FIGS. 6-9, other user inputs are contemplated. For example, in some embodiments, the user input may define a squeeze gesture. In this regard, in some embodiments, the apparatus 102, such as through the processor 110 and/or sensor 118, may be configured to receive the user input by determining that a squeeze gesture is initiated in an instance in which the device is determined to be proximate the first wireless memory tag and released in an instance in which the device is determined to be proximate to the second wireless memory tag. Likewise, in some embodiments, the apparatus 102 may be configured to be worn by a user, such as a wearable mobile computing device (e.g., a wearable glove). In such an embodiment, the user input triggering initiation of the transfer of the data from a first wireless memory tag may define a bending of the wearable device (e.g., a bending of the user's finger within the wearable glove). Further, in some embodiments, user input triggering initiation of the transfer to the second wireless memory tag may define straightening of the wearable device (e.g., straightening of the user's finger within the wearable glove).

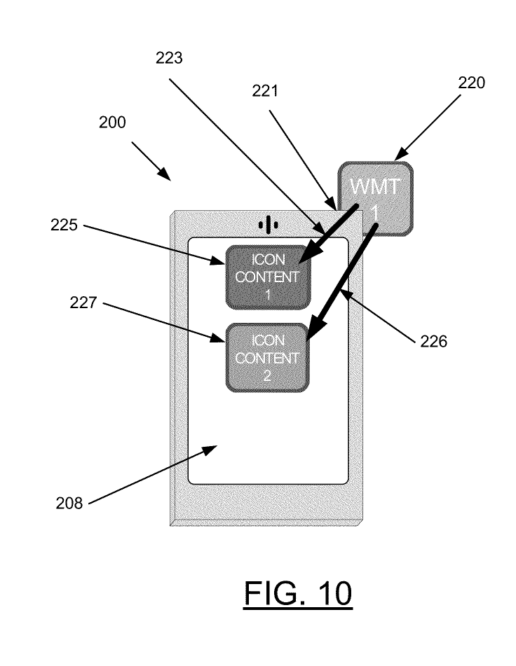

In some cases, more than one set of data may be stored on the wireless memory tag. Said differently, the data on the wireless memory tag may be divided up, such as into files or folders. In some embodiments, the different sets of data may be presented to the user such that the user may decide to interact with only some of the data available on the wireless memory tag. In this regard, in some embodiments, the apparatus 102, such as through the user interface 115, may be configured to cause presentation of a plurality of icons on the display, wherein each icon is associated with different data stored on the wireless memory tag. For example, with reference to FIG. 10, the device 200 may be determined to be proximate the first wireless memory tag 220 (e.g., the device 200 may be in contact 221 with the first wireless memory tag 220). Moreover, the first wireless memory tag 220 may have two sets of data. In such a regard, the device 200 may cause presentation of a representation of the first set of data as icon 225 and a representation of the second set of data as icon 227. In some embodiments, such data sets may be downloaded to the device 200 via one signal or two separate signals (e.g., signals 223 and 226).

In circumstances in which more than one set of data is stored on a wireless memory tag, the user may select which set of data is desired to be transferred. In this regard, with reference to FIG. 10, the user may direct user input to either the first set of data as represented by icon 225 or the second set of data as represented by icon 227. In response, the device 200 may cause the respective set of data to be transferred to the device 200. Such data can then be transferred to a second wireless memory tag as described in greater detail herein. In embodiments in which the apparatus 102 recognizes squeeze gestures, the number of squeezes may correspond to which set of data is being selected by the user. For example, two squeezes may indicate the user's desire to have the second set of data (e.g., icon 227) be transferred to the device 200. In some embodiments, the same procedure for determining which set of data to be transferred from the wireless memory tag may apply to determining which set of data should be transferred to a wireless memory tag. For example, one squeeze may indicate the user's desire to have the first set of data (e.g., icon 225) be transferred to a second wireless memory tag.

Additionally, in some embodiments, the apparatus 102 may be configured to enable transfer of different sets of data from a first wireless memory tag to multiple other wireless memory tags respectively. For example, with reference to FIG. 10, the device 200 may cause transfer of data associated with icon 225 to a second wireless memory tag and the data associated with icon 227 to a third wireless memory tag. In this regard, in some embodiments, the apparatus 102 may be configured to cause transfer of each set of data from the first wireless memory tag to the device. Additionally, the apparatus 102 may be configured to receive user input directed to each set of data to enable transfer of that set of data to a wireless memory tag (e.g., a proximate wireless memory tag). For example, the user may provide user input directed to icon 225 and bring the device 200 proximate a second wireless memory tag. In response, the device 200 may cause transfer of the data associated with icon 225 to the second wireless memory tag. Additionally, however, the user may provide user input directed to icon 227 and bring the device 200 proximate a third wireless memory tag. In response, the device 200 may cause transfer of the data associated with icon 227 to the third wireless memory tag. This process could be repeated for any other wireless memory tags and/or sets of data from a first wireless memory tag.

Additionally, in some embodiments, the apparatus 102 may be configured to enable grouping of sets of data such as to enable easy transfer of the group of sets of data between wireless memory tags. For example, with reference to FIG. 10, a user may wish to group the data associated with icon 225 with the data associated with icon 227, such as for transfer to another wireless memory tag. For example, the apparatus 102 may enable a user to position each of icon 225 and icon 227 into a folder for grouping.

Additionally, in some embodiments, the apparatus 102 may be configured to cause transfer of different sets of data from multiple wireless memory tags to the device. In such a regard, any (or all) of the sets of data may be transferred to other wireless memory tags. Further, in line with some example embodiments described herein, the apparatus 102 may be configured to enable grouping of any sets of data such as to enable easy transfer of the group of sets of data between wireless memory tags. Said differently, data from a first wireless memory tag may be grouped with data from a second wireless memory tag. Then, that group of data may be transferred to a third wireless memory tag.

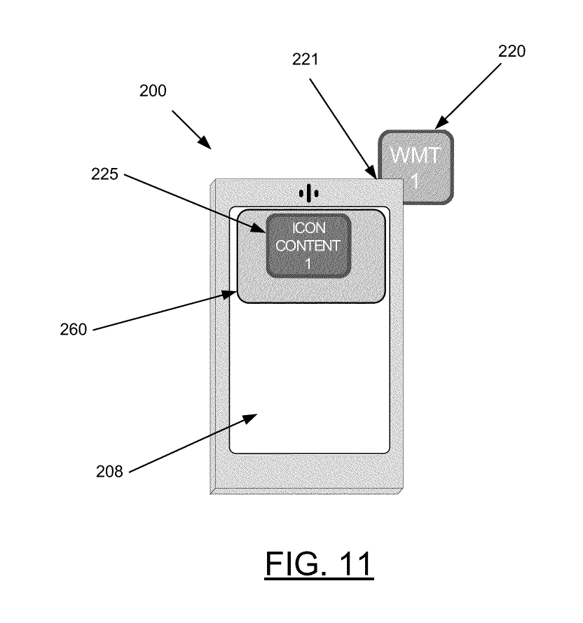

In some embodiments, the apparatus 102, such as through the user interface 116, may be configured to cause presentation of at least one icon associated with data stored on a wireless memory tag within a dedicated portion of the display. In such a regard, the dedicated portion of the display may provide an indication of data available on the wireless memory tag. Moreover, the user may be able to easily differentiate between data stored on the wireless memory tag and data stored within the memory 112 of the apparatus 102. For example, with reference to FIG. 11, the device 200 may be determined to be proximate a first wireless memory tag 220 (e.g., the device 200 may be in contact 221 with the first wireless memory tag 220). The device 200 may read data stored on the first wireless memory tag 220 and may cause presentation of an icon 225 associated with that data. The icon 225 may be presented on the display 208 within a box 260 that represents the current storage of the first wireless memory tag 220.

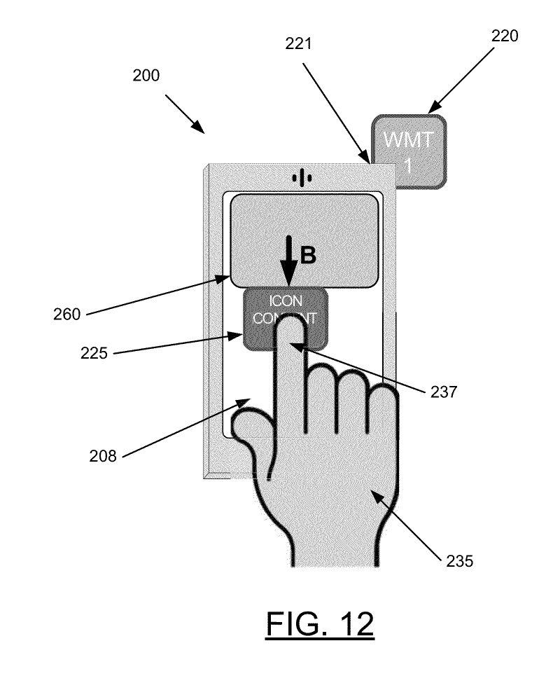

Additionally, in some embodiments, the apparatus 102, such as through the user interface 116, may be configured to receive user input directed to the icon within the dedicated portion of the display indicating a desire to transfer the data to the device. In some embodiments, the user may perform a slide gesture that drags the icon from the portion of the display dedicated to the storage of the first wireless memory tag to another portion of the display. Such a user input may indicate a user's desire to cause transfer of the associated data from the first wireless memory tag to the device. For example, with reference to FIG. 12, a user 235 may perform a slide gesture with their finger 237 being pointed on or near the icon 225. The slide gesture may include sliding the icon 225 from the box 260 to another portion of the display 208 (e.g., along arrow “B”). In response, the device 200 may cause the data associated with icon 225 to be transferred from the first wireless memory tag 220 to the device 200.

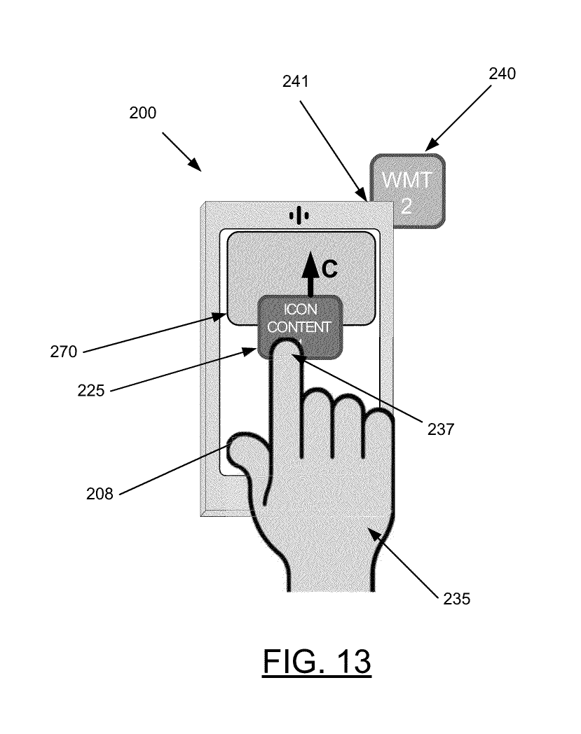

In some embodiments, the apparatus 102, such as through the user interface 116, may be configured to receive user input indicating a desire to transfer data from the device to a wireless memory tag. In some embodiments, the user may perform a slide gesture that drags an icon into the portion of the display dedicated to the storage of the wireless memory tag. Such a user input may indicate a user's desire to cause transfer of the associated data from the device to the wireless memory tag. For example, with reference to FIG. 13, a user 235 may perform a slide gesture with their finger 237 being pointed on or near the icon 225. The slide gesture may include sliding the icon 225 into the box 270 (e.g., along arrow “C”) associated with the storage of a second wireless memory tag 240. In response, the device 200 may cause the data associated with icon 225 to be transferred from the device 200 to the second wireless memory tag 240.

Though the above described embodiments shown in FIGS. 11-13 include providing user input directed to an icon, some embodiments of the present invention contemplate receiving any type of user input for indicating a desire to transfer data to or from a wireless memory tag. For example, the user input may not necessarily need to be directed to an icon. Likewise, a slide gesture defining the user input may not need to accurately place the icon on the display. For example, movement in a certain direction may be sufficient to indicate a user's desire to cause transfer of data to or from a wireless memory tag.

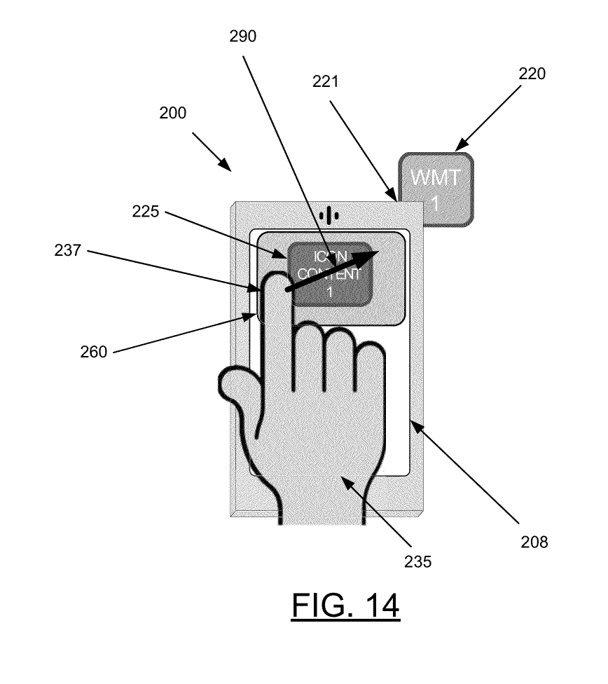

In some embodiments, the apparatus 102, such as through the user interface 116, may be configured to receive user input directed to a representation of at least some data of a wireless memory tag indicating a desire to delete the data. In response, the apparatus 102, such as through the processor 110 and/or communication interface 114, may be configured to cause deletion of the data. Such user input may define any type of user input, such as a swipe gesture or a long push gesture. For example, with reference to FIG. 14, the device 200 may cause presentation of an icon 225 of data from the first wireless memory tag 220. The icon 225 may, in some embodiments, be positioned within a box 260 representing the storage of the first wireless memory tag. A user 235 may provide user input indicating a desire to delete the data associated with the icon 225. For example, the user 235 may perform a swipe gesture with their finger 237 that starts on one side of the icon 225 and carries through to the other side of the icon 222 (e.g., along arrow 290). The device 200 may recognize the swipe gesture and, in response, cause deletion of the data associated with the icon 225.

In some embodiments, an additional message (e.g., a pop-up window) may be presented to the user requesting confirmation of a desire to delete the data. Additionally or alternatively, the apparatus 102, may be configured to cause presentation of the icon in a broken manner (such as ripped down the middle or along the direction of the swipe gesture). Such a presentation would provide an indication to the user that the data has been deleted.

In some embodiments, the apparatus 102 may be configured to create multiple copies of data stored on a wireless memory tag. Along these lines, in some embodiments, the apparatus 102 may be configured to cause each of the copies of data to be transferred to different wireless memory tags. For example, the apparatus 102, such as through the processor 110 and/or user interface 116, may be configured to, in response to determining that a first wireless memory tag is proximate the device, prompt the user to determine whether multiple copies of the data should be made. Based on the user's response, the apparatus 102 may be configured to create multiple copies of the data. Then, the device can be brought into proximity of another wireless memory tag (e.g., a second wireless memory tag). In such a situation, the apparatus 102 may determine that the second wireless memory tag is proximate and cause the data to be transferred to the second wireless memory tag. Further, the user may then bring the device into proximity of yet another wireless memory tag (e.g., a third wireless memory tag). In such a situation, the apparatus 102 may determine that the third wireless memory tag is proximate and cause the same data to be transferred to the third wireless memory tag. Such a process may continue until the user indicates a desire to stop transferring the data to other wireless memory tags.

Additionally or alternatively, the apparatus 102 may be configured to retain a copy of the data after causing transfer of the data to a wireless memory tag for later transfer to another wireless memory tag. In such a situation, there may be no need to create multiple copies of the data. For example, with reference to FIG. 9, after causing transfer of the data associated with icon 225 to the second wireless memory tag 240, the user may indicate a desire to transfer the same data (e.g., the data associated with icon 225) to another wireless memory tag. Such an indication may include any user input (e.g., the user may perform a press and hold gesture directed to the icon 225 a second time). Then, the user may bring the device into proximity of yet another wireless memory tag (e.g., a third wireless memory tag). In such a situation, the apparatus 102 may determine that the third wireless memory tag is proximate and cause the same data to be transferred to the third wireless memory tag. Such a process may continue until the user indicates a desire to stop transferring the data to other wireless memory tags (e.g., by not performing a press and hold gesture directed to the icon 225).

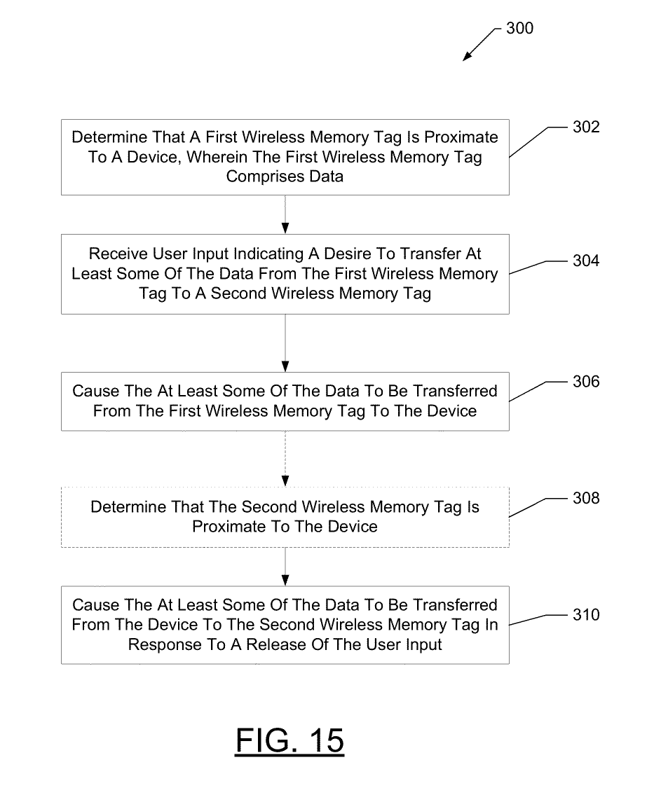

Embodiments of the present invention provide methods, apparatus and computer program products for transferring data between wireless memory tags. Various examples of the operations performed in accordance with embodiments of the present invention will now be provided with reference to FIGS. 15-17.

FIG. 15 illustrates a flowchart according to an example method for transferring data between wireless memory tags according to an example embodiment 300. The operations illustrated in and described with respect to FIG. 15 may, for example, be performed by, with the assistance of, and/or under the control of one or more of the processor 110, memory 112, communication interface 114, user interface 116, sensor 118, or UI control circuitry 122. Operation 302 may comprise determining that a first wireless memory tag is proximate to a device, wherein the first wireless memory tag comprises data. The processor 110, communication interface 114, and/or sensor 118 may, for example, provide means for performing operation 302. Operation 304 may comprise receiving user input indicating a desire to transfer at least some of the data from the first wireless memory tag to a second wireless memory tag. The user interface 116 and/or UI control circuitry 122 may, for example, provide means for performing operation 304. Operation 306 may comprise causing the at least some of the data to be transferred from the first wireless memory tag to the device. The processor 110 and/or communication interface 114 may, for example, provide means for performing operation 306. In some embodiments, operation 308 may comprise determining that the second wireless memory tag is proximate to the device. The processor 110, communication interface 114, and/or sensor 118 may, for example, provide means for performing operation 308. Operation 310 may comprise causing the at least some of the data to be transferred from the device to the second wireless memory tag in response to a release of the user input. The processor 110 and/or communication interface 114 may, for example, provide means for performing operation 310.

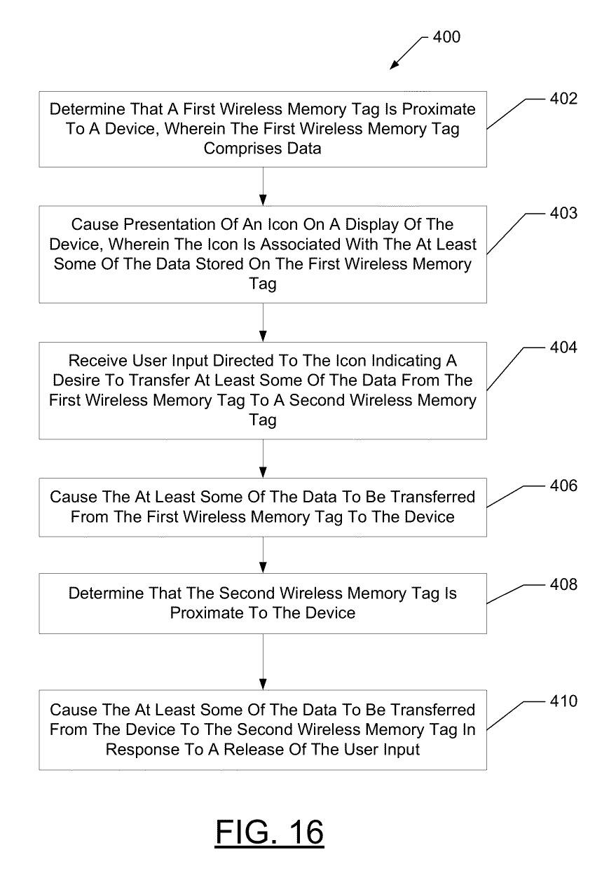

FIG. 16 illustrates a flowchart according to another example method for transferring data between wireless memory tags according to an example embodiment 400. The operations illustrated in and described with respect to FIG. 16 may, for example, be performed by, with the assistance of, and/or under the control of one or more of the processor 110, memory 112, communication interface 114, user interface 116, sensor 118, or UI control circuitry 122. Operation 402 may comprise determining that a first wireless memory tag is proximate to a device, wherein the first wireless memory tag comprises data. The processor 110, communication interface 114, and/or sensor 118 may, for example, provide means for performing operation 402. Operation 403 may comprise causing, in response to determining that the first wireless memory tag is proximate to the device, presentation of an icon on a display of the device, wherein the icon is associated with the at least some of the data stored on the first wireless memory tag. The user interface 116 and/or UI control circuitry 122 may, for example, provide means for performing operation 403. Operation 404 may comprise receiving user input directed to the icon indicating a desire to transfer at least some of the data from the first wireless memory tag to a second wireless memory tag. The user interface 116 and/or UI control circuitry 122 may, for example, provide means for performing operation 404. Operation 406 may comprise causing the at least some of the data to be transferred from the first wireless memory tag to the device. The processor 110 and/or communication interface 114 may, for example, provide means for performing operation 406. Operation 408 may comprise determining that the second wireless memory tag is proximate to the device. The processor 110, communication interface 114, and/or sensor 118 may, for example, provide means for performing operation 408. Operation 410 may comprise causing the at least some of the data to be transferred from the device to the second wireless memory tag in response to a release of the user input. The processor 110 and/or communication interface 114 may, for example, provide means for performing operation 410.

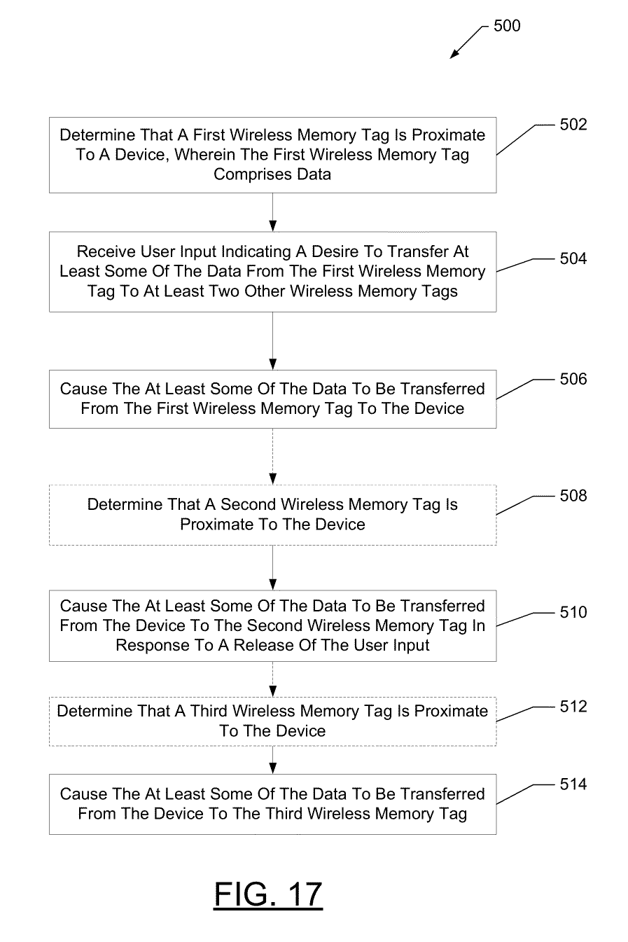

FIG. 17 illustrates a flowchart according to yet another example method for transferring data between wireless memory tags according to an example embodiment 500. The operations illustrated in and described with respect to FIG. 17 may, for example, be performed by, with the assistance of, and/or under the control of one or more of the processor 110, memory 112, communication interface 114, user interface 116, sensor 118, or UI control circuitry 122. Operation 502 may comprise determining that a first wireless memory tag is proximate to a device, wherein the first wireless memory tag comprises data. The processor 110, communication interface 114, and/or sensor 118 may, for example, provide means for performing operation 502. Operation 504 may comprise receiving user input indicating a desire to transfer at least some of the data from the first wireless memory tag to at least two other wireless memory tags. The user interface 116 and/or UI control circuitry 122 may, for example, provide means for performing operation 504. Operation 506 may comprise causing the at least some of the data to be transferred from the first wireless memory tag to the device. The processor 110 and/or communication interface 114 may, for example, provide means for performing operation 506. In some embodiments, operation 508 may comprise determining that a second wireless memory tag is proximate to the device. The processor 110, communication interface 114, and/or sensor 118 may, for example, provide means for performing operation 508. Operation 510 may comprise causing the at least some of the data to be transferred from the device to the second wireless memory tag in response to a release of the user input. The processor 110 and/or communication interface 114 may, for example, provide means for performing operation 510. In some embodiments, operation 512 may comprise determining that a third wireless memory tag is proximate to the device. The processor 110, communication interface 114, and/or sensor 118 may, for example, provide means for performing operation 512. Operation 514 may comprise causing the at least some of the data to be transferred from the device to the third wireless memory tag. The processor 110 and/or communication interface 114 may, for example, provide means for performing operation 514.

FIGS. 15-17 illustrate flowcharts of a system, method, and computer program product according to example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
determining, by a processor, that a first wireless memory tag is proximate to a device, wherein the first wireless memory tag comprises data;
receiving user input indicating a desire to transfer at least some of the data from the first wireless memory tag to a second wireless memory tag;
causing the at least some of the data to be transferred from the first wireless memory tag to the device; and
causing the at least some of the data to be transferred from the device to the second wireless memory tag in response to a release of the user input.

2. The method according to claim 1 further comprising determining that the second wireless memory tag is proximate to the device.

3. The method according to claim 2 further comprising automatically causing, in response to determining that the first wireless memory tag is proximate to the device, the at least some of the data to be transferred from the first wireless memory tag to the device.

4. The method according to claim 2 further comprising causing, in response to determining that the first wireless memory tag is proximate to the device, presentation of an icon on a display of the device, wherein the icon is associated with the at least some of the data stored on the first wireless memory tag.

5. The method according to claim 4, wherein receiving user input indicating a desire to transfer the at least some of the data from the first wireless memory tag to a second wireless memory tag comprises receiving user input directed to the icon.

6. The method according to claim 5, wherein the user input defines a press and hold gesture.

7. The method according to claim 6, wherein receiving the user input comprises determining that the press and hold gesture is initiated in an instance in which the device is determined to be proximate to the first wireless memory tag and released in an instance in which the device is determined to be proximate to the second wireless memory tag.

8. The method according to claim 4, wherein causing presentation of the icon on the display comprises causing presentation of a plurality of icons on the display, wherein each icon is associated with different data stored on the first wireless memory tag.

9. The method according to claim 8, wherein receiving user input indicating a desire to transfer the at least some of the data from the first wireless memory tag to a second wireless memory tag comprises receiving user input directed to at least one of the icons presented on the display, wherein causing the at least some of the data to be transferred from the first wireless memory tag to the device comprises causing the data associated with the at least one selected icon to be transferred from the first wireless memory tag to the device, and wherein causing the at least some of the data to be transferred from the device to the second wireless memory tag comprises causing the data associated with the at least one selected icon to be transferred from the device to the second wireless memory tag.

10. The method according to claim 4 further comprising:
receiving a second user input directed to the icon indicating a desire to delete the at least some of the data associated with the icon; and
causing deletion of the at least some of the data associated with the icon.

11. The method according to claim 1, wherein the user input defines a squeeze gesture.

12. The method according to claim 11, wherein receiving the user input comprises determining that the squeeze gesture is initiated in an instance in which the device is determined to be proximate to the first wireless memory tag and released in an instance in which the device is determined to be proximate to the second wireless memory tag.

13. An apparatus comprising a processor and a memory including computer program code, the memory and the computer program code configured to, with the processor, cause the apparatus to:
determine that a first wireless memory tag is proximate to a device, wherein the first wireless memory tag comprises data;
receive user input indicating a desire to transfer at least some of the data from the first wireless memory tag to a second wireless memory tag;
cause the at least some of the data to be transferred from the first wireless memory tag to the device; and
cause the at least some of the data to be transferred from the device to the second wireless memory tag in response to a release of the user input.

14. The apparatus according to claim 13, wherein the memory and the computer program code are further configured to, with the processor, cause the apparatus to determine that the second wireless memory tag is proximate to the device.

15. The apparatus according to claim 14, wherein the memory and the computer program code are further configured to, with the processor, cause the apparatus to cause, in response to determining that the first wireless memory tag is proximate to the device, presentation of an icon on a display of the device, wherein the icon is associated with the at least some of the data stored on the first wireless memory tag.

16. The apparatus according to claim 14, wherein the memory and the computer program code are further configured to, with the processor, cause the apparatus to receive user input indicating a desire to transfer the at least some of the data from the first wireless memory tag to a second wireless memory tag by receiving user input directed to the icon.

17. The apparatus according to claim 16, wherein the memory and the computer program code are further configured to, with the processor, cause the apparatus to receive the user input by determining that a press and hold gesture is initiated in an instance in which the device is determined to be proximate to the first wireless memory tag and released in an instance in which the device is determined to be proximate to the second wireless memory tag.

18. The apparatus according to claim 15, wherein the memory and the computer program code are further configured to, with the processor, cause the apparatus to cause presentation of the icon on the display by causing presentation of a plurality of icons on the display, wherein each icon is associated with different data stored on the first wireless memory tag.

19. Computer program product comprising a non-transitory computer readable medium having program code portions stored thereon, the program code portions being a computer readable medium and configured when said program product is run on a computer or network device, to:
determine that a first wireless memory tag is proximate to a device, wherein the first wireless memory tag comprises data;
receive user input indicating a desire to transfer at least some of the data from the first wireless memory tag to a second wireless memory tag;
cause the at least some of the data to be transferred from the first wireless memory tag to the device; and
cause the at least some of the data to be transferred from the device to the second wireless memory tag in response to a release of the user input.

20. The computer program product according to claim 19, wherein the program code portions are further configured, when said program product is run on a computer or network device, to determine that the second wireless memory tag is proximate to the device.
